(19) United States
(12) Patent Application Publication
(10) Pub. No.: US 2002/0085661 A1
(43) Pub. Date: Jul. 4, 2002

(54) Propulsion system for space vehicle

(76) Inventor: Dale J. Retter, Scottsdale, AZ (US)

Correspondence Address: LAVALLE D. PTAK, LAW OFFICE OF LAVELLE PTAK, 28435 N 42ND STREET, SUITE B, CAVE CREEK, AZ, 85331, US

(21) Appl. No.: 09/753,305

(22) Filed: Dec. 30, 2000

(51) Int. Cl. G21D 1/00; G21C 23/00

(52) U.S. Cl. 376/318

(57) ABSTRACT

A propulsion system for a space vehicle is designed as a fully self-contained system which does not eject particles to effect the propulsion, referred to as a “reactionless drive”. Propulsion is effected by changing the mass of rings of charged particles by acceleration of the rings of charged particles to velocities near the speed of light and back to a rest or near rest speed in an oscillatory manner. While this is taking place, the charged particles are moved back-and-forth within a contained housing to impart thrust when the large mass particles are moved, and allowing the return of the low mass particles to the original starting place before imparting high velocity rotation to increase the mass of the particles. The average velocity is less than the actual velocity; so that if the vehicle is placed within a singularity, the singularity might travel faster than light without passing through a condition where the vehicle mass approaches infinite mass.

### BACKGROUND

In order for a space craft to traverse the distances to other planets, or even to other solar systems, long periods of sustained thrust are necessary to achieve the substantial velocities required to reduce the travel time. A major limitation on the duration of thrust imposed by conventional propulsion systems is that these systems require the forceful ejection of some type of reaction mass in order to produce the thrust. No matter how much energy is available, mass must, by all known prior art, be ejected from the vehicle in order for the vehicle in space to achieve through its own actions, any acceleration.

One of the basic laws of motion, as stated by Isaac Newton, is that “every action has an equal and opposite reaction”. This law frequently is interpreted to imply (what heretofore also has been an empirical rule) that an internal action cannot cause an external change in momentum. For example, land vehicles act on the ground, airplanes and ships act on the external fluid mass contacting them. In accordance with this principle, a vehicle in space must impart an equal and opposite momentum change to ejected mass in order for the vehicle to undergo a change in its momentum. For example, with rocket propulsion, the momentum change imparted to a rocket is equal to the momentum change imparted to the mass it has ejected as rocket exhaust.

External forces, such as light, can cause a change in momentum. There are problems, however, inherent in the propulsion of a vehicle being provided by a source external to the vehicle. These problems tend to increase with the distance separating the vehicle from its external energy source.

Recent developments by different physicists have opened the door to new possibilities for propulsion systems for space vehicles. An article by M. Millis, entitled “Challenge to Create the Space Drive” in Journal of Propulsion and Power (AIAA), Vol. 13, No. 5, pp 557-682 (September-October 1997) is directed to this challenge. In this article, Mr. Millis explores the possibilities of a self-contained means of propulsion that requires no propellent. As defined in this article, a space drive is an idealized form of propulsion where the fundamental properties of matter and space time are used to create propulsive forces anywhere in space, without having to carry and expel a reaction mass. Such an achievement, according to Mr. Millis, would revolutionize space travel, as it would circumvent the present constraint of requiring a propellant. In this article, seven different hypothetical propulsion concepts have been considered. All of the concepts were envisioned by considering analogies to collision forces and interactions with fields to produce net forces.

One technique by which a space vehicle may be propelled utilizes collision sails. In order for this hypothetical technique to work, the medium of space may be considered as a form of isotropic medium which is constantly impinging on all sides of a vehicle. It is hypothesized by Mr. Millis that if collisions on the front of a vehicle could be lessened and/or the collisions on the back enhanced, a net propulsive force would result.

Another approach taken by Mr. Millis is hypothetical field drives, of which four types, namely “diametric drive”, “pitch drive”, “bias drive” and “disjunction drive” are presented. All of these are considered to induce an asymmetric field, such that a gradient is located at the center of the vehicle, or more specifically, at the center of whatever part of the vehicle will experience a reaction force from the field. The asymmetric field is required so that a net force is created on the vehicle by these drives. Although four hypothetical field drives are discussed in this paper, the manner in which they can be produced in actuality is not disclosed.

Two recent articles available on the worldwide computer network are “The Speed of Light—a Limit on Principle ?“, Feb. 3, 1998 by Laro Schatzer and Superluminal Motion: Fact or Fiction ? by Ryan Frewin, Renee George, Deborah Paulson. Both of these papers deal with the assumption in contemporary physics that no object should be able to travel faster than the speed of light. The reason given for this is that the relationship between velocity and mass is such that, hypothetically, at the speed of light the mass of an object becomes infinite. The scientific analysis in both of these articles is that the speed of light may not be a true physical limit. Whether or not the speed of light is a limit depends on the structure of the space-time continuum, which presently is unknown. If absolute time (and a preferred reference frame) exists, then faster than light speeds, and even faster than light travel, are possible.

Although the theory of special relativity states against absolute time and superluminal phenomana, it does so not by proof, but only by assumption. According to Schatzer, if our universe has a Newtonian background, that is if there is an absolute time underlying the space-time continuum, then there is no thread on causality by superluminal processes, because time travel and its paradoxes are excluded a priori. Thus, within this framework, faster than light travel is possible in principle. Mr. Schatzer, however, concludes that in order to construct a propulsion mechanism for faster than light travel, exotic matter (with imaginary mass) probably would be needed in order to produce negative energy densities in space. According to Mr. Schatzer, exotic matter is not known to exist, although negative energy densities have been shown to appear in quantum field theory.

In the Frewin et al. article, there is a discussion of various experiments which measured the tunneling times of visible light through optical filters, finding that tunneling photons traveled at multiples of the speed of light through air. The conclusion reached by the authors is that conclusive evidence is given for faster than light transmission of smoothly varying functions, such as that of a particle wave packet. In the opinion of the authors, this means that it is possible for an object to have a velocity greater than that of light. As stated in this article, “Einstein causality rules out the propagation of any signal traveling faster than light, but it does not limit the group velocity of electromagnetic propagation.”

Accordingly, it is desirable to provide a means by which a vehicle in space may cause its own velocity and direction of travel to be altered without the ejection of reaction mass.

### SUMMARY OF THE INVENTION

It is an object of this invention to provide a new means of vehicular propulsion which uses changes in mass induced by acceleration of rings of charged particles to relativistic (near light) velocities.

It is another object of this invention to provide a system of propulsion for a space vehicle using reactionless generation of

It is an additional object of this invention to provide a means of propulsion for a space vehicle having the potential for speeds of travel which exceed the speed of light while avoiding the problem of the mass of an object increasing exponentially as it approaches the speed of light.

In accordance with the preferred embodiment of this invention, a propulsion system for a space vehicle includes an elongated enclosure for housing rings of charged particles. The speed of rotation of the rings of charged particles is varied from a relatively low rotational speed to a rotational speed approaching the speed of light, and back again to the low rotational speed on a continuing repetitive rate of oscillation. Simultaneously, while the rotational speed of the particles is changed from the relatively low speed to a high speed and back again, the rings of charged particles themselves are linearly moved in the elongated enclosure back-and-forth from one end to the other, in synchronization with the repetitive rate of change of the speed of rotation of the rings of charged particles. By doing this, a heavy mass is moved from one end of the tube to the other; and a lighter mass is moved back to the starting end to impart a reactionless drive to any vehicle to which the propulsion system is attached.

### BRIEF DESCRIPTION OF THE DRAWINGS

FIG. 1 is a diagrammatic representation of a preferred embodiment of the invention;

FIGS. 2A through 2D illustrate the manner of operation of the system shown in FIG. 1;

FIG. 3 is a legend useful in understanding the operation described in FIG. 2;

FIG. 4 is a cross-sectional view of another embodiment of the invention;

FIG. 5 is a top view of the embodiment shown in FIG. 4; and

FIG. 6 is a diagrammatic representation of the operation of the vehicle shown in FIGS. 4 and 5.

### DETAILED DESCRIPTION

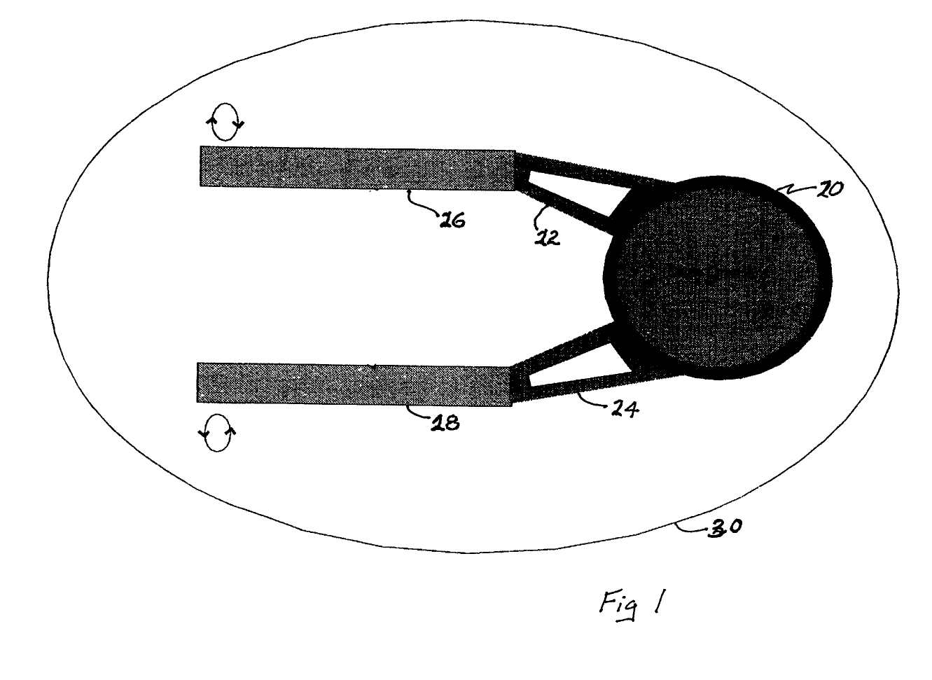

Reference now should be made to the drawings, which illustrate two different embodiments of the invention. In FIG. 1, a space vehicle is illustrated with a pair of long-thrust reactionless drive engines attached to it. The vehicle itself comprises a crew cabin 20, which is attached by means of appropriate structure and radiation shields 22 and 24 to a pair of elongated tubular reactionless drive engines 26 and 28. The engines 26 and 28 comprise closed tubes similar to those used in research instruments, such as cyclotrons or synch-cyclotrons.

Located within the tubes 26 and 28 are rings composed of charged particles in the form of electrons, positrons, protons, or plasmas. Electrostatic and magnetic fields are produced in the manner utilized with cyclotrons to rotate the rings of charged particles about the central axis of each of the tubes 26 and 28. The charged particle accelerators are used to accelerate the particles to a relativistic velocity, such that the mass of the particles being accelerated increases substantially above the rest mass (due to the particles achieving a velocity which represents a significant fraction of the velocity of light).

In order to counteract the rotational forces which are produced, the particles in the propulsion housing 26 are rotated, for example, clockwise about the central axis of the tube or housing 26, while the particles in the tube or housing 28 are rotated counterclockwise. By using a pair of parallel drive engines 26 and 28 employing charged particles rotating in opposite directions, the opposing torques applied through the engines to the cabin 20 of the space craft is canceled.

It is known that in large accelerators, the particles can achieve hundreds or even thousands of times their rest mass. Consequently, after the rotating particles are rotated to a velocity high enough to increase their mass, both rings of particles then are linearly accelerated in a direction parallel to their axis of rotation, and opposite to that in which the craft containing them is desired to move. This is illustrated in FIG. 2, showing the heavy mass (high velocity spin) particles being moved in FIG. 2A from right to left. In accordance with the operative law of physics that every action has an equal and opposite reaction, this movement imparts a forward movement (in FIG. 1, toward the right) to the vehicle. If the rings of charged particles were allowed to permanently separate from the space craft and continue their travel without further interference from the craft, this operation would simply represent a typical example of rocket propulsion, with the enhancement of having the mass of particles ejected increased because of their high relativistic velocity.

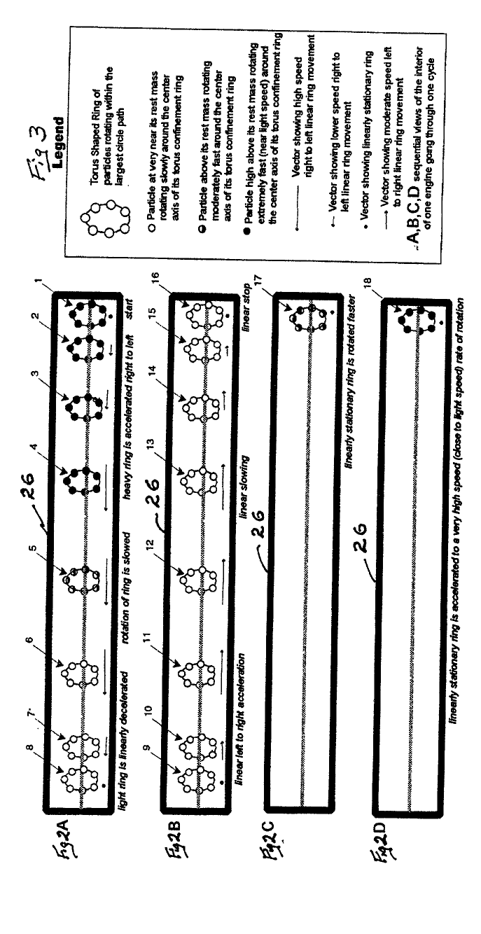

In the space craft illustrated in FIG. 1, and the operation of which is described in FIGS. 2 and 3, the rotational velocities of the rings of accelerated charged matter (the charged particles) is reduced or slowed as they undergo linear motion from right to left (as viewed in FIGS. 1 and 2). If, however, the rotational velocities of the rings of accelerated charged matter is not changed, and the rings were to be slowed in their linear motion, parallel to their axis of rotation and retained by the vehicle, all of the forward momentum imparted to the vehicle during their linear acceleration would be canceled out. This is because decelerating the velocity of the particle rings relative to the vehicle, until they matched the velocity of the vehicle, would completely cancel out the forward momentum imparted by the linear acceleration to the rings in the first instance.

In the system of the preferred embodiment of the invention shown in FIG. 1, and the operation of which is described in FIGS. 2 and 3, the rotating charged particles are accelerated in a linear direction (from right to left, as shown in FIG. 2) long and hard enough to impart forward momentum increase to the vehicle. Then, the rotational velocities of the particle rings in both engines 26 and 28 are slowed equally and sufficiently to cause the increased mass (which the particles achieved by relativistic rotational speed) to decrease. Both rings of rotating particles, which then are retained by the craft inside the engines 26 and 28, are decelerated such that their linear velocity once again matches that of the vehicle generally. Since the mass of these rings during the linear deceleration, however, now is less than the mass they possessed when they were rotating faster, decelerating the now lighter, slower rotating rings from left to right, as illustrated in FIG. 2B, causes less reduction in forward momentum when the linear motion of the rings is slowed to match that of the vehicle. This results because the momentum change caused by decelerating the particles linearly was obtained when they were first linearly accelerated in their heavier state induced by the higher rotational velocity.

The net result, therefore, is an achievement of net momentum change without the ejection of reaction mass. The process, as indicated in FIGS. 2A through 2D and 3, may be continuously repeated as long as there is sufficient energy available to drive it. It should be noted that this drive mechanism achieves an external change in velocity without ejecting any mass; and this accomplished without violating any known laws of physics.

The operation of the space craft to propel it forward requires a synchronization of the acceleration and deceleration of the spin of the particles, along with the impartation of magnetic forces to achieve the movement of the particles from one end of the engine tube to the other, and back again. Heavy particles are moved from the left to the right of the engine as viewed in FIGS. 1 and 2, and light particles are moved from right to left to return the rings to the original position. In the original position the charged particles once again are accelerated to achieve a high mass prior to moving them from the right end to the left end of the engines 26 and 28 in a repeat of the cycle. This results in an oscillatory synchronous operation of the linear forces and the rotational forces imparted to the particles. These forces may be applied by any known means for achieving high speed particle movement, such as achieved in cyclotrons and the like.

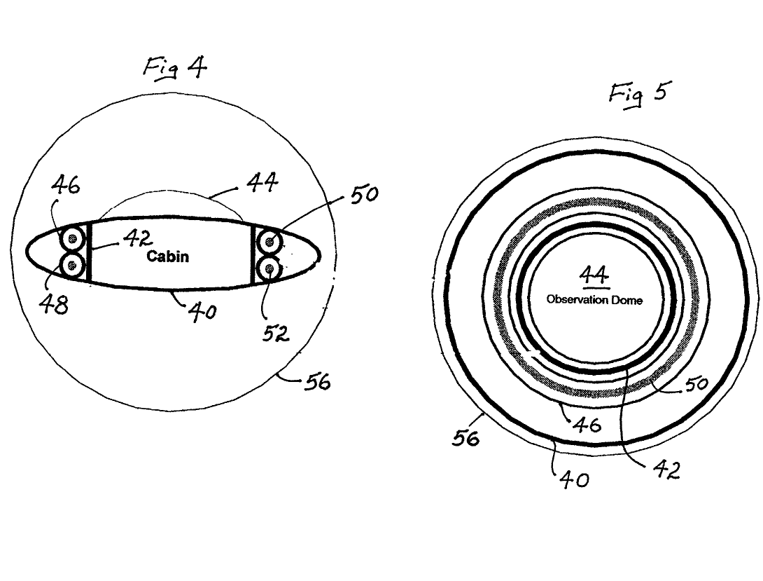

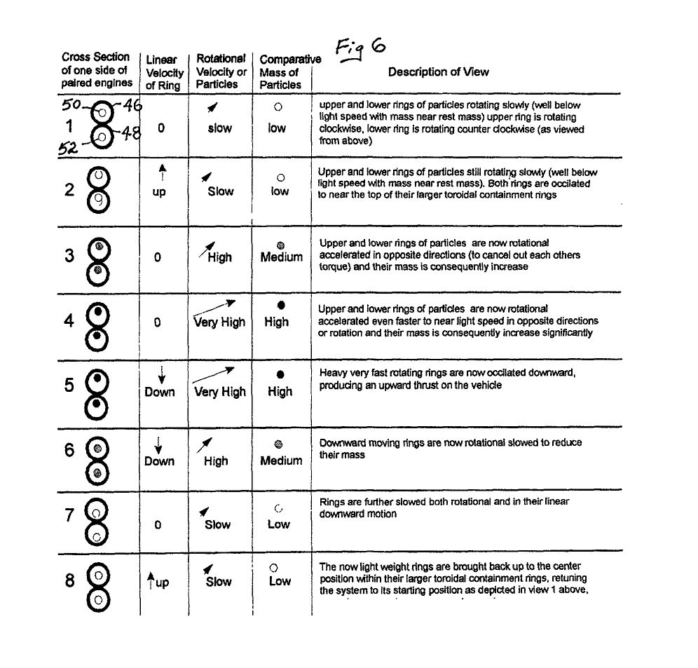

Reference now should be made to FIGS. 4 and 5, which illustrate another embodiment of the invention employing the same basic operating principles, but constructed in the form of a circle or toroidal ring instead of the linear engine employed with the embodiment of FIG. 1. In the embodiment shown in FIGS. 4 and 5, the crew quarters or cabin 40 is located at the center portion of the space craft. This cabin 40 is provided with a radiation shield 42 encircling it to separate it from the outer portion of the space vehicle, which includes two hollow tubular circular rings 46 and 48 forming a pair of engines for propelling the vehicle. These rings 46 and 48 each have a center located on the axis passing vertically through the cabin 40, as shown in FIG. 4. They are of equal size, and have equal diameter. Each of these rings 40 and 48 have charged particles in them which are operated on by electrostatic and magnetic fields to rotate around circles located within each of the engines 46 and 48, in the same manner described previously in conjunction with FIG. 1 for spinning or rotating the charged particles. The particles are operated upon in the sequence described in FIG. 6 to accelerate them to a large mass and decelerate them to a rest mass, and back again to a large mass, in a cyclical manner similar to the manner of cyclically varying the rotational velocity (and, therefore, the mass) of the particles as described in conjunction with FIG. 1.

As described in section 1 of FIG. 6, the particles initially rotate slowly (and they are rotated in opposite directions, for example, the upper ring rotating clockwise and the lower ring rotating counterclockwise) for the reasons given above in the discussion of FIG. 1. The rotational velocity of the particles in step 1 of the engine operating cycle shown in FIG. 6 is slow; and the comparative mass of the particles is low, as described previously. The rings of particles then are moved upward (as viewed in FIG. 4) to a position near the top of the respective circular tubes comprising the engines 46 and 48. This is shown in step 2 of FIG. 6. The rotational velocity of the particles then is increased while they are in this position until it achieves a very high relative rotational velocity, as shown in step 4 of FIG. 6. Once the high rotational velocity, increasing the mass of the particles significantly by rotating the rings of particles to a near light speed, in opposite directions of rotation has been achieved, electromagnetic forces are used to move the particles downwardly in the engine compartments, as illustrated in FIGS. 4 and 6. This imparts an upward thrust on the overall vehicle.

As shown in steps 6 and 7, the rotational velocity of the particle rings then is reduced; and the rings of charged particles continue to move downwardly until at step 8 they are at the same position as the starting position shown in step 1. The cycle then is repeated. Once again, the cyclical coordination between the up and down or linear movement and the increased rotational velocity and decreased rotational velocity of the rings is coordinated to effect the pumping or oscillatory impartation of energy to the space craft in a manner similar to that described above in conjunction with FIG. 1.

It should be noted that it is theoretically possible to have a space craft, such as the space crafts 20 or 40, operated under the described reactionless drive to have an average velocity of 99% of the speed of light, but with an actual velocity which may be greater than 99% of the speed of light. At the same time, the individual particles in the rotating rings still would not be able to be moved forward at a velocity overly close to light speed because of the resultant increase in mass. It is considered possible, however, for the entire space craft 20 or 40 to be enclosed in some container or field, such that the entire craft reacts with the universe as a single object. Such conditions are believed to be possible in very special and usually very small zones. These small zones possessing this property are referred to as singularities. Black holes may be one form of a large singularity. Therefore, it is at least theoretically possible that other forms of large scale singularities exist, or can eventually be created. If, for example, a vehicle driven through space with a reactionless drive achieves an average velocity of 98% of the speed of light, and then is enclosed in a singularity such that the mass of the entire object might be determined by its average velocity, a condition where the average velocity is lower than the speed of light might be obtained, where the actual velocity is higher than the speed of light. In practice, this will allow for a vehicle to approach the speed of light using a reactionless space drive, then wrap itself in a singularity; so that the entire average velocity of the vehicle determines its mass. Although the average velocity of the vehicle would not and could not exceed the speed of light, the actual velocity of the vehicle could be higher than its average velocity; so that its actual velocity might exceed light speed. This condition is achieved because the average velocity of the vehicle is the actual forward velocity of the vehicle, plus the internal forward velocity of the particle rings moving forward relative to the vehicle, minus the internal backward velocity of the particle rings moving backward relative to the vehicle. Since the rings are oscillating backward and forward in equal amplitudes, and the mass of the rings moving backward is greater than the mass of the rings when they are moving forward, the net result in computing the average velocity is a subtraction from the actual velocity. Therefore, the actual velocity will be greater than the average velocity.

At first examination, the achievement of a speed only a small amount above light speed might seem like a minor, although symbolically important event. Such an achievement, however, may have profound consequences. It is possible that when an object exceeds light speed, it ceases to exist in the time flow of our normal universe. Thus, the object may be able to traverse distances during faster than light travel without any time elapsing relative to our normal universe time flow. As a consequence, this may allow a faster-than-light vehicle to travel faster than light for a distance of many light years, and then turn off the singularity and drop back into the normal time flow of the universe and be a considerable number of light years from its origin without the passage of the otherwise required number of years of travel time relative to the normal time flow of the universe.

It is possible that an object traveling faster than light in this described manner will become virtually invisible, since the quantum electrodynamics (QED) interaction with photons, with an object traveling faster than light, may not result in the normal absorption and readmission of photons required to produce a visible object. The one known property of matter that may not be so affected is its gravity. Therefore, matter traveling faster than light may appear invisible or dark, yet its presence may still be detectable because the mass would continue to produce detectable gravity. Since the majority of matter believed to exist in the universe appears to be dark matter (detectable, so far, only by its gravitational field) , it is possible that this matter is in fact traveling faster than light.

The foregoing description of the preferred embodiment of the invention is to be considered as illustrative and not as limiting. various changes and modifications will occur to those skilled in the art for performing substantially the same function, in substantially the same way, to achieve substantially the same result without departing from the true scope of the invention as defined in the appended claims.

What is claimed is

1. A propulsion system for a space vehicle including in combination:
an elongated enclosure for containing rings of charged particles;
means for rotating the rings of charged particles from a relatively low rotational speed to a rotational speed approaching light speed, and back to the relatively low rotational speed at a repetitive rate of oscillation;
means for linearly moving the rings of charged particles back and forth within the housing in synchronism with the repetitive rate of change of the speed of rotation of the rings of charged particles.

2. A propulsion system for a space vehicle according to claim 1 wherein the elongated enclosure comprises an elongated tube with a central axis and having first and second ends, wherein the rings of charged particles are rotated about the central axis of the tube and are moved by said means for linearly moving the rings of charged particles from the first end of the tube at which the particles have maximum rotational speed to the second end of the tube, with the rotational speed of the rings of charged particles slowing incrementally during the move of the rings of charged particles to the second end, where the rings of charged particles have the relatively low rotational speed, and the rings of charged particles are moved back to the first end at the relatively low rotational speed for each cycle of operation.

3. The propulsion system according to claim 2 wherein the charged particles are electrons.

4. The propulsion system of claim 3 wherein the means for controlling the speed of rotation of the rings of charged particles is a cyclotron.

5. The propulsion system according to claim 3 wherein multiple rings of charged particles are confined within the elongated enclosure for simultaneous rotation by the means for controlling the speed of rotation of the rings of charged particles and for simultaneous back-and-forth movement by the means for linearly moving the rings of charged particles.

6. The propulsion system according to claim 5 wherein the composition of the material of the rings of charged particles is selected to undergo nuclear fusion to produce energy in addition to imparting momentum change through the means for controlling the speed of rotation of the rings of charged particles and means for linearly moving the rings of charged particles back-and-forth.

7. The propulsion system according to claim 1 comprising first and second elongated enclosures for containing rings of charged particles, with the rings of charged particles in the first elongated enclosure rotating clockwise, and the rings of charged particles in the second enclosure rotating counterclockwise, and further including a cabin enclosure connected with the first and second elongated enclosures.

8. The propulsion system according to claim 7 wherein the first and second elongated enclosures comprise first and second elongated tubes each having first and second ends and a central axis with the rings of charged particles in the first elongated tube rotating clockwise about the central axis thereof and the rings of charged particles in the second tube rotating counterclockwise about the central axis thereof, and with the elongated tubes oriented parallel to one another.

9. The propulsion system according to claim 8 wherein the cabin enclosure is connected to the elongated enclosures by means of a radiation shield.

10. The propulsion system according to claim 9 wherein the charged particles are electrons.

11. The propulsion system of claim 10 wherein the means for controlling the speed of rotation of the rings of charged particles is a cyclotron.

12. The propulsion system according to claim 8 wherein the counter rotating rings of charged particles are simultaneously accelerated and decelerated by the means for rotating the charged particles to an equal degree, so as to cancel the rotational torque generated by the rings of charged particles as they are accelerated and decelerated.

13. The propulsion system according to claim 1 wherein the elongated enclosure comprises first and second hollow tubular rings of equal diameter and stacked one on top of the other in parallel planes for housing first and second rings of charged particles, respectively, with the rings of charged particles in the first hollow tubular ring rotating clockwise when viewed in a first cross section and the rings of charged particles in the second hollow tubular ring rotating counterclockwise when viewed in the same cross section, and wherein the means for linearly moving the charged particles moves the charged particles of both rings back and forth perpendicular to the planes of the first and second hollow tubular rings.

14. The propulsion system according to claim 13 further including a cabin enclosure and wherein the first and second tubular rings surround the cabin enclosure.

15. The propulsion system according to claim 14 wherein the cabin enclosure is connected to the elongated enclosures by means of a radiation shield.

16. The propulsion system according to claim 15 wherein the charged particles are electrons.

17. The propulsion system according to claim 16 wherein the counter rotating rings of charged particles are simultaneously accelerated and decelerated by the means for rotating the charged particles to an equal degree, so as to cancel the rotational torque generated by the rings of charged particles as they are accelerated and decelerated.

18. The propulsion system according to claim 1 wherein the space vehicle is enclosed in a singularity.

19. The propulsion system according to claim 1 wherein multiple rings of charged particles are confined within the elongated enclosure for simultaneous rotation by the means for controlling the speed of rotation of the rings of charged particles and for simultaneous back-and-forth movement by the means for linearly moving the rings of charged particles.

20. The propulsion system according to claim 1 wherein the composition of the material of the rings of charged particles is selected to undergo nuclear fusion to produce energy in addition to imparting momentum change through the means for controlling the speed of rotation of the rings of charged particles and means for linearly moving the rings of charged particles back-and-forth.

21. The propulsion system according to claim 1 wherein the charged particles are electrons.

22. The propulsion system of claim 21 wherein the means for controlling the speed of rotation of the rings of charged particles is a cyclotron.
